(19) United States
(12) Patent Application Publication
(10) Pub. No.: US 2014/0328159 A1
(43) Pub. Date: Nov. 6, 2014

(54) Recovery of Split Architecture Control Plane

(71) Applicants: Paolo Rebella, Bergeggi (IT); Diego Caviglia, Savona (IT); Daniele Ceccarelli, Genova (IT)

(72) Inventors: Paolo Rebella, Bergeggi (IT); Diego Caviglia, Savona (IT); Daniele Ceccarelli, Genova (IT)

(73) Assignee: Telefonaktiebolaget L M Ericsson (publ), Stockholm (SE)

(21) Appl. No.: 14/361,368

(22) PCT Filed: Nov. 29, 2011
(86) PCT No.: PCT/EP2011/071245

§ 371 Date: Jun. 30, 2014

(51) Int. Cl. H04L 12/24

(52) U.S. Cl. CPC H04L 41/0672; H04L 41/0873
USPC 370/218

(57) ABSTRACT

A method of operating a control plane having a centralised network management system (10), control domain servers (20) and a plurality of forwarding elements (30), for controlling respective network entities (L2), and grouped into control domains (21, 22, 23). Each domain has a control domain server. Automatic checking for inconsistencies (110, 115, 210, 310, 320, 450) between the records held at the different parts of the control plane, involves comparing checklists of the records of the circuits stored at the different parts of the control plane. If an inconsistency is found, there is automatic updating (120, 220, 230, 460) of the records using a copy sent from another of the parts of the control plane. The checklists can avoid the need to forwarding entire copies.

### FIELD

The present invention relates to methods of operating a control plane for a communications network, to control domain servers for such control planes, to network management systems for such control planes, and to corresponding computer programs for operating such control planes.

### BACKGROUND

Control planes are known for various types of communications networks. They can be applied to access networks, to metro, to core networks and all the intermediate types, pushing for solutions that will soon span from end to end. The control plane has well known advantages including, among the others, significant OPEX and CAPEX savings, traffic restoration and so on. However the control plane has two main drawbacks:
1. Scalability issues
2. Low control of the network operator on the paths used by the traffic in end to end services with consequent lack of resource optimization.

Different flavors of control plane (i.e. Centralized or Distributed) can be used to mitigate one of the two drawbacks but unavoidably makes the other one even worse. The centralized approach, for example, allows a better control of the resource of the network, improves their utilization and reduces concurrent resource utilization to the minimum (or even zero in some cases), but it has great scalability issue. On the other side the distributed approach allows a fully automated management of very big networks, with the unavoidable problem of worse control of the resources being used.

One new approach is based on a split architecture (split between control plane and forwarding plane) that allows a better trade-off between the two above mentioned difficulties and thus potentially enables better performance on the network. The architecture is based on three pieces of equipment:
1. NMS
2. Control Domain server
3. Forwarding Element

Forwarding Elements are grouped into domains, each of which has a Control Domain server “speaking” the control plane protocols and presenting its domain outside the boundaries as a single Network Element with a number of interfaces equal to the number of Forwarding Elements. What happens inside each domain is only a concern of the Control Domain server. The set up, tear down and restoration of LSPs is done by the Control Domain server via management plane interactions. There is no control plane message flowing between the forwarding elements of each domain, just a dumb forwarding by the border nodes towards the Control Domain server.

Coordination of actions of these three parts of the control plane can be degraded after recovery from a failure.

### SUMMARY

Embodiments of the invention provide improved methods and apparatus. According to a first aspect of the invention, there is provided a method of operating a control plane having a central network management system, one or more control domain servers coupled to the network management system, and a plurality of forwarding elements, for controlling respective network entities, and grouped into control domains. Each domain has one of the control domain servers coupled to the forwarding elements of that domain to manage control plane signalling for the domain. The network management system has record of the circuits set up in all of the control domains, and the forwarding elements have a record of those of the circuits set up to use its respective network entity. After a failure in a part of the control plane, amongst the control domain server, the forwarding elements, and the network management system, communications is re-established between those parts of the control plane affected by the failure. There is a step of checking automatically for inconsistencies between the records held at the different parts of the control plane, caused by the failure, by comparing checklists of the records of the circuits stored at the different parts of the control plane. If an inconsistency is found, the records at the part or parts affected by the failure are updated automatically using a copy of a corresponding but more up to date record sent from another of the parts of the control plane.

A benefit of these features is that the updating can enable the reliability of the network to be improved since inconsistencies are likely to cause further failures. Notably since the checking can be achieved without forwarding entire copies to or from the NMS, this means the improved reliability can be achieved more efficiently as the quantity of control plane communications and processing resource needed can be reduced. Thus the arrangement is more scaleable. See FIGS. 2 and 3 for example.

Any additional features can be added, some such additional features are set out below. The method can have the step of using the control domain server to generate a checklist for any of the forwarding elements of its control domain based on the records held at the respective forwarding element, for use in the step of checking for inconsistencies. By centralising the generating of the checklist for each domain this can enable the forwarding element to be simpler and not need to generate the checklist, and thus be more compatible with existing or legacy standards. See FIG. 4 for example.

Another such additional feature is the checking step comprising forwarding a checklist of the records between the control domain server and the network management system, and using either the network management system or the control domain server to compare the checklists for the records held at the different parts without forwarding entire copies of all the records between the network management system and the control domain server. By concentrating the checking at the network management system or the control domain server, this can help make the process more efficient and thus scalable. See FIG. 5 or FIG. 6 for example.

Another such additional feature is at least one of the control domain servers being arranged to maintain a record of current checklists for the forwarding elements of their domain. This can help enable quicker checking by avoiding the need to generate the checklist on the fly. See FIG. 4, or 5 or 6 for example.

Another such additional feature, in case of the failure being at the network management system, of using the checklist in the records at the control domain server, for the comparing step, comparing with corresponding information in the records at the network management system. This can enable check to be made more efficiently, particularly if it avoids the need to transfer more details from the CDS or the FE. See FIGS. 4 and 5 for example.

Another such additional feature is the checking for inconsistencies comprising, for the case of the failure being at the control domain server, of generating current checklists at the control domain server by requesting a copy of circuit information from the records at the forwarding elements in the respective domain. This can enable more efficient operation and thus more scalability by sending a reduced amount of information sufficient checking without sending all the records unless needed for updating. See FIG. 7 or FIG. 8 for example.

Another such additional feature is the checking step also comprising the step of comparing the current checklist at the control domain server with corresponding information in the records at the network management system. This can help enable the check to be more efficient as it avoids the need to end all the records, if there turns out to be no inconsistency. See FIG. 5 or 7 for example.

Another such additional feature is the updating step comprising the steps of: the control domain server sending a request to selected ones of the forwarding elements to send a copy of the record which needs updating, the control domain server forwarding the copy to the network management system, and the network management system using these to update its records in relation to the respective forwarding elements. This can enable the updating to be more efficient if the CDS selects which records to forward rather than forwarding all the records. See FIG. 5 or 7.

Another such additional feature is the checking for inconsistencies comprising, for the case of the failure being at one of the forwarding elements, of the steps of: the forwarding element sending to the control domain server an indication that the forwarding element needs to rebuild its records, and the control domain server sending this indication on to the network management system. This could enable the FE to do the checking and enable the CDS to control the updating. See FIGS. 9 and 10 for example.

Another such additional feature is the updating step comprising the network management system selecting from its records, information about any circuits using the respective forwarding element, and sending this to the control domain server, the control domain server sending this information to the forwarding element, and the forwarding element updating its records. This can enable the CDS to control the updating. See FIGS. 9 and 10 for example.

Another such additional feature is using the updated records at the parts of the control plane in a restoration procedure for restoring a failed circuit by rerouting onto a new route. In this procedure there is a particular need for consistency of records otherwise the new route may not be set up and valuable customer traffic may be lost while any inconsistency is being resolved.

Another aspect of the invention provides a control domain server for a control plane of a communications network, the control plane having a central network management system, one or more control domain servers coupled to the network management system, and a plurality of forwarding elements, for controlling respective network entities, and grouped into control domains, each domain having a respective one of the control domain servers coupled to the forwarding elements of that domain to manage control plane signalling for the domain. The network management system has a record of the circuits set up in all of the control domains, the forwarding elements have a record of those of the circuits set up to use its respective network entity, and the control domain server has parts arranged to re-establish communication between those parts of the control plane affected by the failure, then check for inconsistencies between the records held at the different parts of the control plane, caused by the failure. The control domain server also has a part arranged for updating, if an inconsistency is found, the records at the part or parts affected by the failure, by requesting a copy of a corresponding but more up to date record from the respective forwarding element or from the network management system, and forwarding the copy on to the other of these.

A possible additional feature is the control domain server having a part arranged to generate a checklist for any of the forwarding elements of its control domain based on the records held at the respective forwarding element, for use in the step of checking for inconsistencies.

Another such additional feature is the control domain server having a part arranged to maintain a record of current checklists for the forwarding elements of their domain.

Another aspect of the invention provides a network management system for a control plane of a communications network, the control plane also having one or more control domain servers coupled to the network management system, and a plurality of forwarding elements for controlling respective network entities, and grouped into control domains, each domain having a respective one of the control domain servers coupled to the forwarding elements of that domain to manage control plane signalling for the domain. The network management system has a record of the circuits set up in all of the control domains, the forwarding elements has a record of those of the circuits set up to use its respective network entity, and the network management system has parts for re-establishing communication between those parts of the control plane affected by the failure, then checking for inconsistencies between the records held at the different parts of the control plane, caused by the failure. If an inconsistency is found, the records affected by the failure are updated by requesting a copy of a corresponding but more up to date record from the respective forwarding element.

Another aspect of the invention provides a computer program on a computer readable medium, for operating a control plane of a communications system, the control plane having a central network management system, one or more control domain servers coupled to the network management system, and a plurality of forwarding elements, for controlling respective network entities, and grouped into control domains. Each domain has a respective one of the control domain servers coupled to the forwarding elements of that domain to manage control plane signalling for the domain, the network management system having a record of the circuits set up in all of the control domains, and the forwarding elements having a record of those of the circuits set up to use its respective network entity. The computer program has instructions which when executed by a processor or processors at one or more parts of the control plane amongst the control domain server, the network management system and the forwarding element cause the processor or processors to re-establish communication between those parts of the control plane affected by the failure, then check for inconsistencies between the records held at the different parts of the control plane, caused by the failure. If an inconsistency is found, the records at the part or parts affected by the failure, are updated by requesting a copy of a corresponding but more up to date record from the respective forwarding element or from the network management system, and forwarding the copy on to the other of these.

Any of the additional features can be combined together and combined with any of the aspects. Other effects and consequences will be apparent to those skilled in the art, especially over compared to other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of an example of a network having a split architecture control plane having a number of domains, on which the embodiments of the invention can be used,

FIG. 2 shows a schematic view of one of the domains in more detail,

FIG. 3 shows method steps for realignment according to a first embodiment,

FIG. 4 shows steps according to another embodiment,

FIGS. 5 to 10 show particular realignment procedures following different types of failure,

FIG. 11 shows a timing chart for timers involved in the procedures, and

FIGS. 12 and 13 show schematic views of a CDS and an NMS respectively.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

### ABBREVIATIONS

### ABR Area Border Router

### AIS Alarm Indication Signal

### ADM Add&Drop Multiplexing

### AGN Access Grid Node

### AN Access Node

### CBR Constant Bit Rate

### CPRP Control Plane Resizing Protocol

### DCN Data Communications Network

### FE Forwarding Element

### GFP Generic Framing Procedure

### GMP Generic Mapping Procedure

### HO-ODUk High Order ODUk

### LDP Label Distribution Protocol

### T-LDP Targeted Label Distribution Protocol

### ODUk Optical Data Unit

### OPUk Optical Payload Unit

### OTN Optical Transport Network

### OTUk Optical Transport Unit

### PE/ABR Planning Entity/ABR

### RP Resizing Protocol

### SAR Segmentation And Reassembling

### TS Tributary Slot

### GMPLS Generalized MultiProtocol Label Switching

### PCE Path Computation Element

ROADM Reconfigurable optical add drop multiplexer/demultiplexer

### RSVP-TE Resource Reservation Protocol—Traffic Engineering

### SNMP Simple Network Management Protocol

### TCO Total Cost of Ownership (CAPEX+OPEX)

### WSON Wavelength Switched Optical Network

CAPEX Capital expenditure
OPEX Operating expenditure

### DEFINITIONS

Where the term “comprising” is used in the present description and claims, it does not exclude other elements or steps and should not be interpreted as being restricted to the means listed thereafter. Where an indefinite or definite article is used when referring to a singular noun e.g. “a” or “an”, “the”, this includes a plural of that noun unless something else is specifically stated. Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of switching node, not limited to the types described, not limited to any level of integration, or size or bandwidth or bit rate and so on.

References to switches can encompass switches or switch matrices or cross connects of any type, whether or not the switch is capable of processing or dividing or combining the data being switched.

References to software can encompass any type of programs in any language executable directly or indirectly on processing hardware.

References to processors, hardware, processing hardware or circuitry can encompass any kind of logic or analog circuitry, integrated to any degree, and not limited to general purpose processors, digital signal processors, ASICs, FPGAs, discrete components or logic and so on. References to a processor are intended to encompass implementations using multiple processors which may be integrated together, or co-located in the same node or distributed at different locations for example.

References to optical paths can refer to spatially separate paths or to different wavelength paths multiplexed together with no spatial separation for example.

References to circuits can encompass any kind of circuit, connection or communications service between nodes of the network, and so on,

References to a checklist can encompass any kind of summarised version of the complete information describing the circuits set up, such as a list of the identities of the circuits, a compressed version of the complete information, information which indirectly references the circuit identities and so on.

References to Control Domain Server are intended to encompass any centralized entity able to manage control plane signaling and routing for a set of Forwarding Elements.

References to Forwarding Elements are intended to encompass entities within a network node which are able to manage data plane and control plane signaling.

### Introduction

By way of introduction to the embodiments, how they address some issues with conventional designs will be explained.

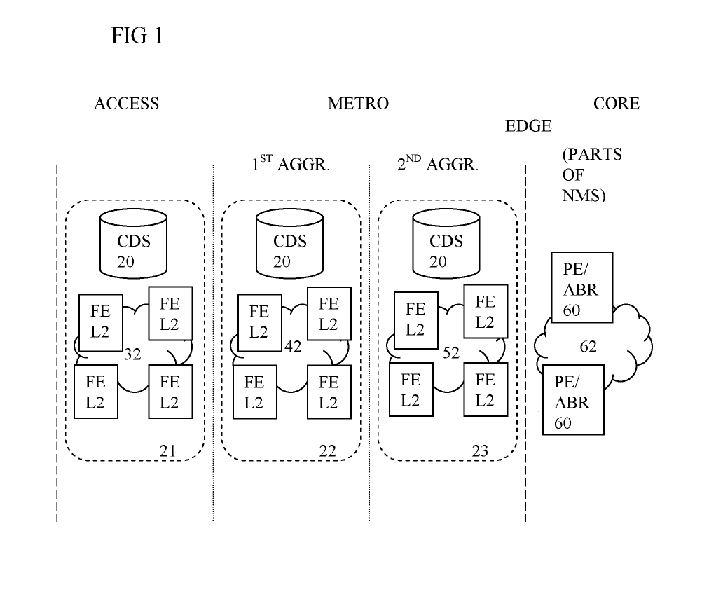

### FIGS. 1,2, Split Architecture Control Plane

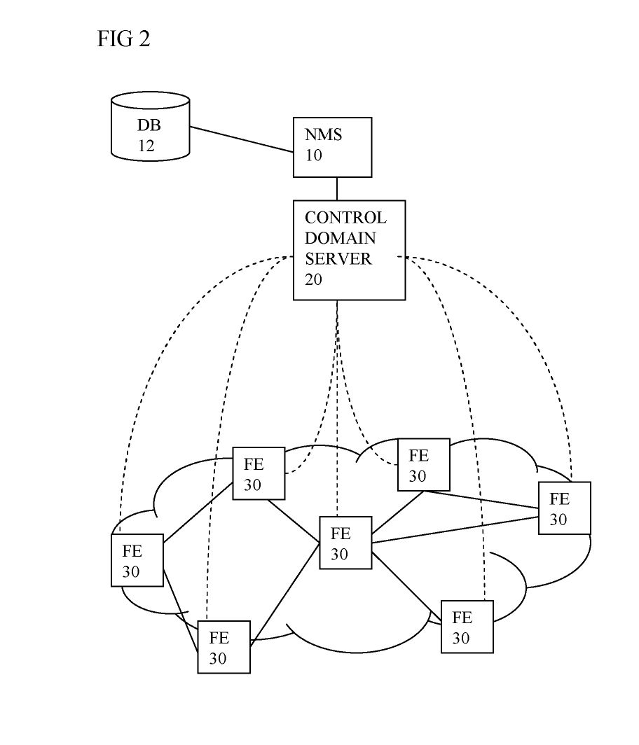

FIG. 1 shows a schematic view of an example of a network having a split architecture control plane having a number of domains, on which the embodiments of the invention can be used. FIG. 2 shows a schematic view of one of the domains in more detail.

The split architecture high level concept is illustrated in FIG. 1. Individual clouds 32, 42, 52 represent groups of transport aggregation nodes FE L2 being forward elements FE of the control plane and switching or aggregating nodes. The groups each make up one administrative split architecture control domain, each domain having its own control domain server 20. Domain 21 is a domain with a group 32 of access nodes FE L2. Domain 22 has a group 42 of 1^{St} level aggregation nodes at a metro level of the hierarchy. Domain 23 has a group 52 of 2nd level aggregation nodes at a metro level of the hierarchy. The core part of the network has parts of a network management system including a planning entity and routing entity PE/ABR 60 distributed around several nodes in the core represented by cloud 62.

The routers adjacent to any of the domains act as though they are connected to a single LSR node. In fact the clouds are seen externally as a single IP node independently of the actual implementation within the domain itself. Such description can be also referred to as “aggregation network as a platform”. A good comparison to understand this concept would be the analogy of the split architecture domain corresponding to a multi-chassis system, where multiple line cards are grouped and controlled by a Routing Engine centrally located in a dedicated platform. (where Control Domain server is analogous to the central Routing Engine, and the Forwarding Elements correspond to the different chassis).

FIG. 2 shows a single domain, which can be for the entire network, or can be one domain of a multi domain network. A cloud represents the many nodes of the network, and some or each of the nodes have a forwarding element 30 having a connection to the CDS 20. The CDS in turn has a connection to the NMS 10, representing the parts of the NMS concerned with the control plane. A database 12 is shown coupled to the NMS having the records for all the circuits set up in the network. The CDS may have some record of the circuits set up such as a checklist for the circuits of its domain.

This type of split architecture can provide the same type of services and features as today's IP centric MPLS networks. By having a shared rather than an independent Control Plane, as new services are added, the processing requirements increase and the likelihood of one service affecting another also increases; therefore, the overall stability of the system may be affected. For instance, having an IP VPN service, a virtual private LAN service (VPLS), and an Internet service running on the same router, the routing tables, service tunnels and other logical circuits are scaled together, and at some point will combine to exceed limits that each would not reach alone. When introducing new services in this environment, there is the need to perform compound scaling and regression testing—in both the lab and in the field—and determine how these services are affecting each other. However, by removing the tight coupling between control and forwarding planes of a router, each can be allowed to have new degrees of freedom to scale and innovate. Customers, sessions and services can scale on one hand, or traffic can scale on the other hand, and neither control nor traffic scaling will be dependent on the other. Virtualization advantages an also arise: there is no need to deploy different NEs for different services. True convergence can arise because of Network segmentation and isolation between geographically and/or operational separate domains, or because of Network simplification and isolation. Also, considering a Transport operational model, from an IP & control plane perspective, the problem of managing 100 s to 1000 s of Access/Aggregation nodes can be simplified to managing a small set (1 s to 10 s) of nodes. From a NE perspective, the 100 s to 1000 s of Access/Aggregation nodes can be managed similar to the way Transport nodes are operated: failures are treated as HW or physical connectivity problems which can be fixed by changing physical parameters, e.g. replace HW modules, chassis', system reboot, replace fiber or pluggable optical module etc. HW issues are reported to server as alarms which can give operational staff information about how to troubleshoot problems.

Speaking of traditional control plane features:

Signaling, which today is done by RSVP-TE, LDP or T-LDP (in case of distributed approach) can be handled as follows in the split architecture:
In single-domain scenarios, centralize TED state to allow for a single point of visibility to the network. This is a similar capability to that provided already by NMS systems.
In multi domain scenarios, it would allow performing an e2e provisioning either at the MPLS or at the PW layer. This would be feasible because, from the ABR perspective, the split architecture module would make the whole “Domain” appear as if it was a single NE speaking the same protocols as the ABR. For example, if a LDP signaling is ongoing on the core cloud, such signaling will not need to be terminated at the corresponding ABR, but it can transparently be extended towards the domain. It will be Control Domain server duty to trigger the appropriate actions towards the cloud to make the signaling take place as expected. A more detailed explanation will be given below. This is not available in current IPT-NMS.

Regarding the Routing functionality, the same reasoning as above for the signaling is also valid.
In single-domain scenarios, would centralize RIB state to allow for a single point of visibility to the network.
In the multi domain case split architecture should be able to speak BGP, IBGP and ISIS with the ABR on behalf of the domain, thus enabling an e2e service setup. This is not available in current IPT-NMS.

Regarding path computation, this can be performed distributed -by the head NE (Ingress node)- or centrally by the NMS. The split architecture can offer added value in terms of multi-technology (for example packet and optical) coordination or for easily implementing specific algorithms not included in the existing solutions.

Regarding dynamic recovery (restoration), this is usually a distributed functionality performed by the control plane. Centralizing this would mean having a real time interaction between the network and the central element (the split architecture module in this case). This behavior is not available today in the current packet IPT-NMS.

Split architecture is not intended for replacing the NMS in the already available centralized functionality. In fact the NMS is typically designed for planning and provisioning activity that defines long-term characteristics of the network which typically have lifespan of months to years. The parts of the control plane having split architecture are meant for “real-time” automation for handling live operational events that frequently change. Moreover, the split architecture module of the NMS can be co-located or in many cases not co-located with the rest of the NMS if it is preferred to allow more flexibility and more independence from a single supplier.

Referencing the seamless MPLS (draft-ietf-mpls-seamless-mpls) model, split architecture would enable such a deployment in the case of Aggregation and Access NEs not supporting the protocols required (IBGP, ISIS, LDP). The split architecture in this case would take the role of control plane agent to handle ISIS, iBGP and LDP signaling on behalf of the AGN and AN nodes.

### GMPLS

Generalized Multiprotocol Label Switching (GMPLS) provides a control plane framework to manage arbitrary connection oriented packet or circuit switched network technologies. Two major protocol functions of GMPLS are Traffic Engineering (TE) information synchronization and connection management. The first function synchronizes the TE information databases of the node in the network and is implemented with either Open Shortest Path First Traffic Engineering (OSPF-TE) or Intermediate System to Intermediate System Traffic Engineering (ISIS-TE). The second function, managing the connection, is implemented by Resource ReSerVation Protocol Traffic Engineering (RSVP-TE).

The Resource ReSerVation Protocol (RSVP) is described in IETF RFC 2205, and its extension to support Traffic Engineering driven provisioning of tunnels (RSVP-TE) is described in IETF RFC 3209. Relying on the TE information, the GMPLS supports hop-by-hop, ingress and centralized path computation schemes. In hop-by-hop path calculation, each node determines only the next hop, according to its best knowledge. In the case of the ingress path calculation scheme, the ingress node, that is the node that requests the connection, specifies the route as well. In a centralized path computation scheme, a function of the node requesting a connection, referred to as a Path Computation Client (PCC) asks a Path Computation Element (PCE), to perform the path calculations, as described in IETF RFC 4655: “A Path Computation Element (PCE)-Based Architecture”. In this scheme, the communication between the Path Computation Client and the Path Computation Element can be in accordance with the Path Computation Communication Protocol (PCEP), described in IETF RFC 5440.

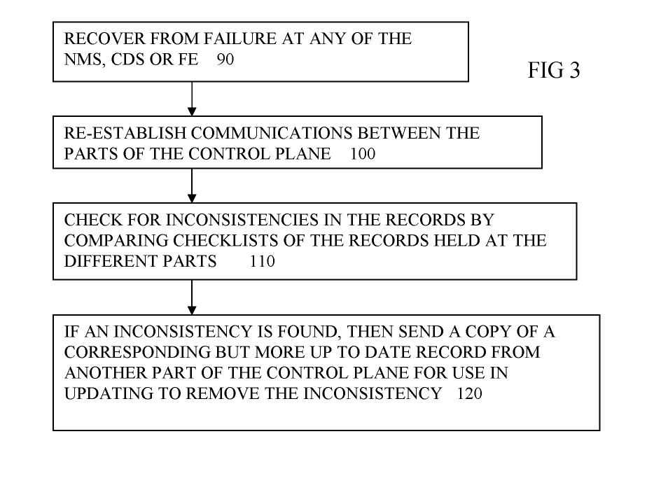

### FIG. 3, Method Steps for Realignment According to a First Embodiment,

A problem related to these types of split architecture is the possibility of misalignment between the entities which are located apart, between the Control Domain server and its Forwarding Elements, and between the NMS which is always present, and the other entities.

In order to have the whole architecture correctly working, the three entities should always be aligned in the sense of them having data records which are consistent, particularly the records of circuits which are currently set up. Misalignment can be caused by either problems on the DCN or by a temporary outage of one of them. When the connection is restored the databases may be have out of date information and thus be inconsistent with each other.

To address the misalignment issue, there is a realignment procedure, having the steps shown in FIG. 3 to be used after a failure in case a misalignment between the 3 entities (NMS, CDS, FE) occurs. At step 90, there is recovery from the failure. At step 100 communications are re-established between the parts of the control plane, that is the NMS, the CDS, and the FEs. There is a check for inconsistencies by comparing checklists of the records held at the different parts at step 110. If an inconsistency is found, then a copy of a corresponding but more up to date record is sent from another part of the control plane for use in updating to remove the inconsistency as shown at step 120.

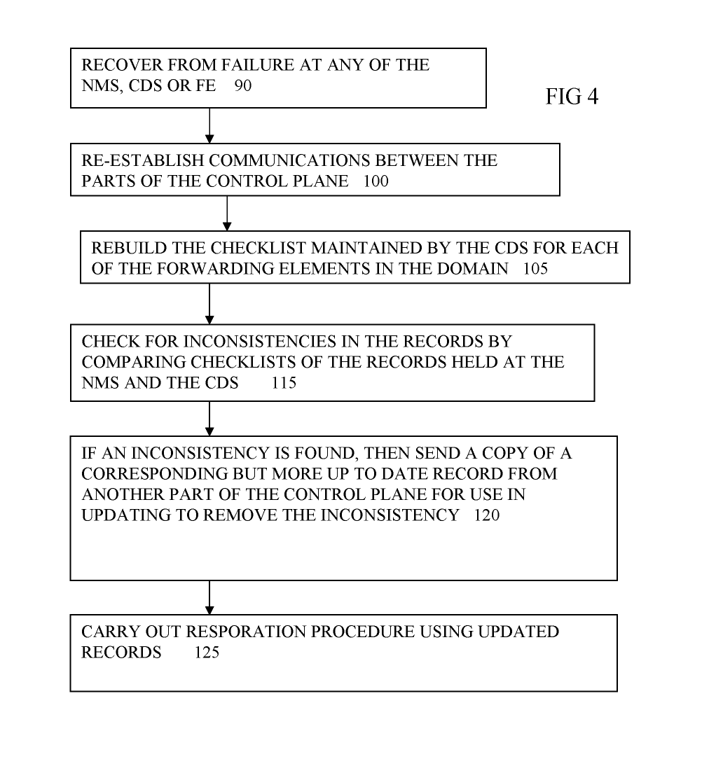

### FIG. 4, Method Steps for Realignment According to a First Embodiment

FIG. 4 shows steps according to another embodiment, similar to that of FIG. 3 but with some additional features. As before, at step 90, there is recovery from the failure. At step 100 communications are re-established between the parts of the control plane, that is the NMS, the CDS, and the FEs. At step 105, a checklist maintained by the CDS, of circuits set up in the nodes for each of the forwarding elements in the domain, is rebuilt. A check for inconsistencies in the records is then made by comparing checklists of the records held at the NMS and the CDS at step 115. As before, if an inconsistency is found, then a copy of a corresponding but more up to date record is sent from another part of the control plane for use in updating to remove the inconsistency as shown at step 120.

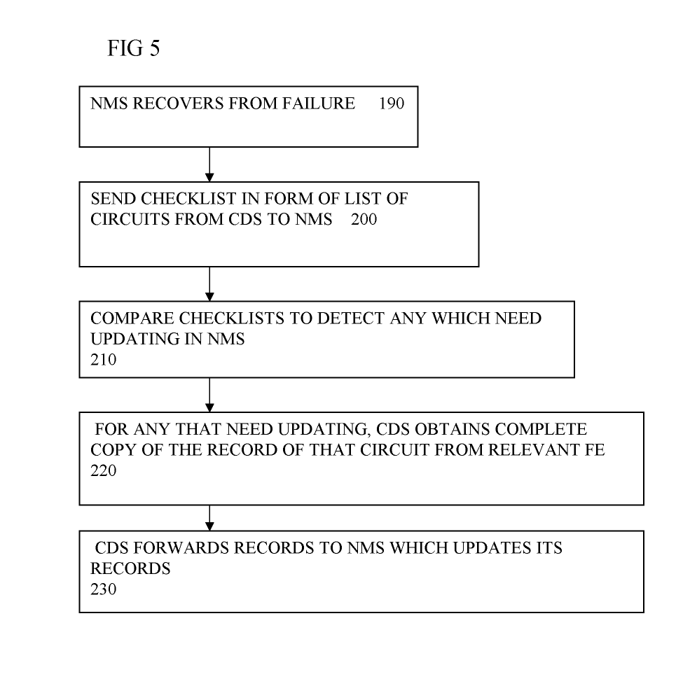

### FIGS. 5 to 10, Particular Realignment Procedures for Different Types of Failure

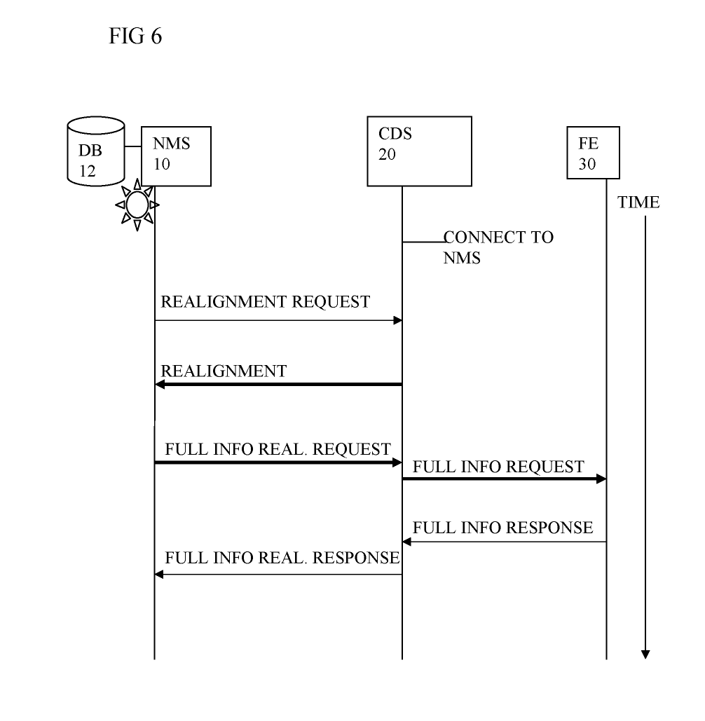

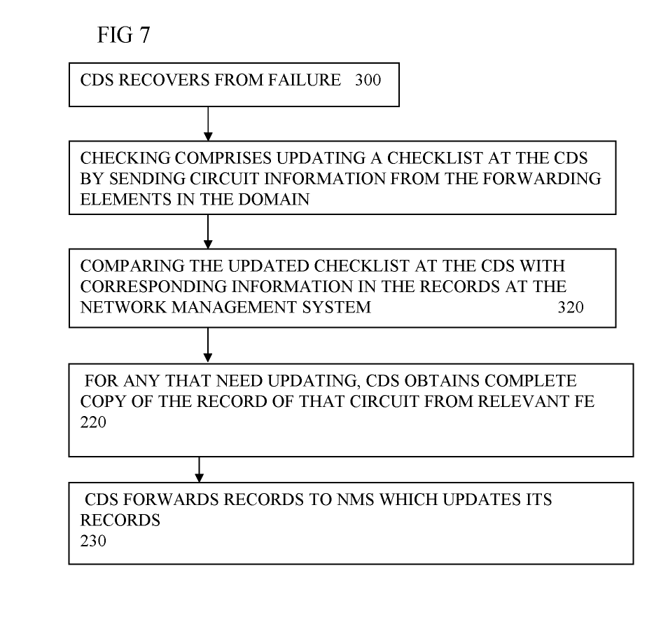

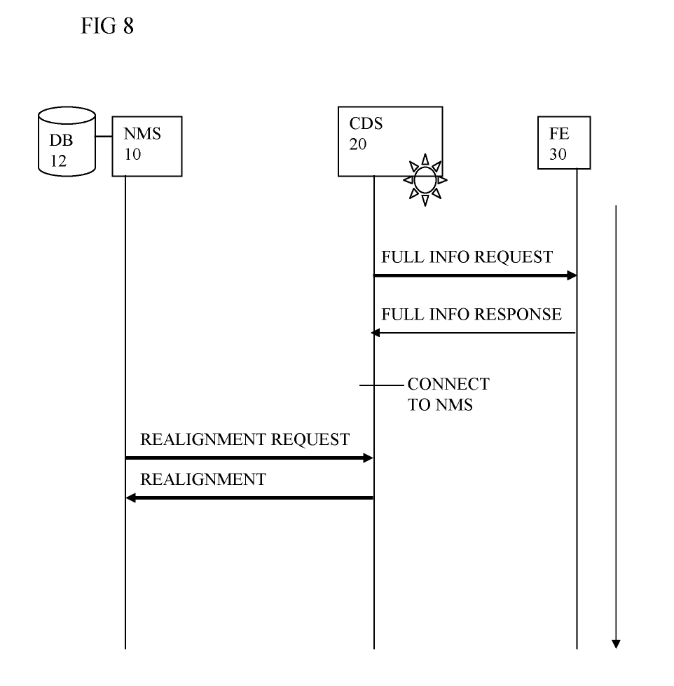

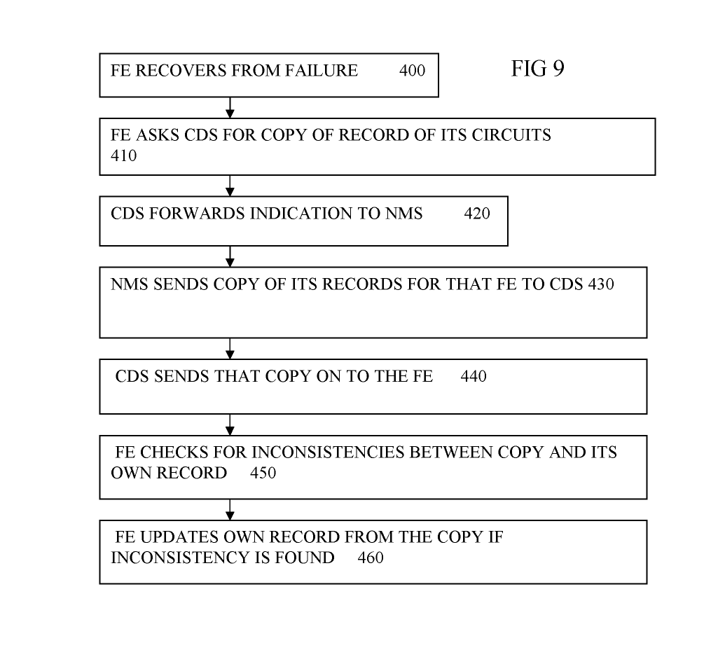

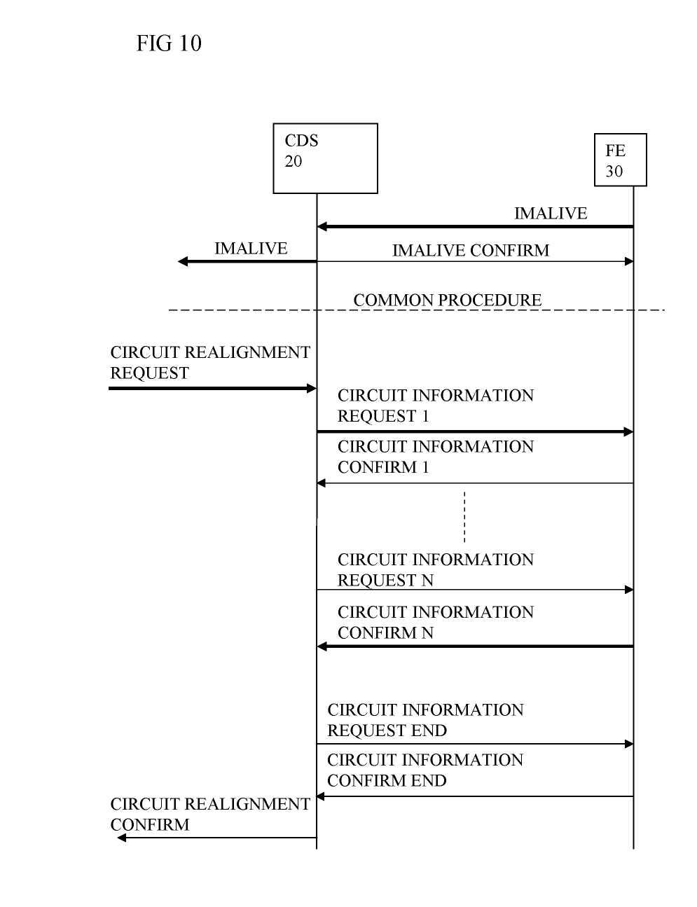

Three sub-procedures are defined in the following, respectively covering the failure and recovery of the NMS (FIGS. 5 and 6), the Control Domain Server (FIGS. 7 and 8) or a Forwarding Element (FIGS. 9 and 10). The type of protocol running between the various entities could be of any type (e.g. SNMP, Open Flow, Net Conf) so generic names are used for the messages and they can be applied to any configuration/management protocol.

### FIGS. 5 and 6, NMS Database Misalignment

FIG. 5 shows steps of an embodiment similar to that of FIG. 4 or 5, but specific to the case of the failure being at the NMS, or in the communication with the NMS. At step 190, the NMS recovers from the failure and communication is re-established. At step 200, a checklist in the sense of a list of identities of circuits set up through nodes in the domain, is sent from the CDS to the NMS. At step 210, the checklists are compared to detect any which need updating. In principle this comparison could be carried out at the CDS or at the NMS. If the CDS, then the NMS would have to send its copy to the CDS. At step 220, for any of the records that are inconsistent and need updating, the CDS obtains a complete copy of the record of that circuit from the relevant FE. At step 230, the CDS forwards the complete copy from the FE to the NMS which updates its records.

FIG. 6 shows a time chart of parts of a similar procedure according to an embodiment. Time flows downwards. Actions of the NMS and its database are at the left side. Actions of the CDS are in a central column, and actions of the FE are at the right side. This figure illustrates an example of the message flow in the case that the NMS fails. In this case the NMS cannot be sure about the status of its records and thus an update is requested to the Control Domain server. The following steps take place in this example, described partly in pseudo code terms. Many variations can be envisaged.
1. As soon as the NMS comes up again, the CDS sends requests for reopening communication;
2. The NMS accepts the (for example TCP/IP) connection request
3. NMS sends to all the CONTROL DOMAIN servers it controls a Realignment Request for all the nodes for which the circuit list empty, that is, an UpDate for all Call is requested;
4. The CONTROL DOMAIN server replies with t (t is the number of Ingress FEs under the control of CONTROL DOMAIN servers) Realignment Response messages. Each response contains the Recovery Status information about the LSPs for which the FE is Ingress node.
5. At the receiving of the Realignment Response messages the NMS verifies if the Call information it contains is consistent with the one it has stored in its DataBase.
   If (Number of Call>stored Call) then sends a FullInfo Realignment Response for the missing LSPs, and z is the number of such missing LSPs.
   If (Realignment Response indicates some FE as ReStarted) then after the NMS has finished its re-alignment with the FEs an Information message is sent to the CONTROL DOMAIN server for that FE; Goto point 10.
   If (Realignment Response indicates some FE NotResponding) then do nothing; Goto point 10
   If (Number of LPS in Realignment Response==than the stored LSP) then do nothing; Goto point 10
6. If a CDS receives the FullInfo Realignment Request it builds a FullInfo Request. This message is sent to a corresponding FE and requests full info for the z LSPs missing in the NMS DataBase
7. The FE receives the FullInfo Request and replies with z FullInfo Response messages, and each one of those messages is LSP based and contains the full info for that LSP
8. Once the CDS has received all the FullInfo Response related to its request it builds a FullInfo Realignment Response and sends it to the NMS
9. At the receiving of the FullInfo Realignment Response the NMS updates its database.
10. If the processed message is not the last then return to point 5

### End of the Procedure.

### FIGS. 7 and 8, CDS Misalignment

FIGS. 7 and 8 show examples illustrating the scenario in which the CDS fails.

In FIG. 7, the CDS recovers from failure at step 300. Checking comprises updating a checklist at the CDS by sending circuit information from the forwarding elements in the domain at step 310. At step 320 the updated checklist is compared at the CDS with corresponding information in the records at the network management system. Again in principle this can be done either at the CDS or at the NMS. At step 220, for any of the records that are inconsistent and need updating, the CDS obtains a complete copy of the record of that circuit from the relevant FE. At step 230, the CDS forwards the complete copy from the FE to the NMS which updates its records.

FIG. 8 shows a time chart of parts of a similar procedure according to an embodiment. Time flows downwards. Actions of the NMS and its database are at the left side. Actions of the CDS are in a central column, and actions of the FE are at the right side. This figure illustrates an example of the message flow in the case that the CDS fails. In this case the CDS cannot be sure about the status of its records and thus an update is requested to some or all of its FEs. The following steps take place in this example, described partly in pseudo code terms. Many variations can be envisaged. The number of the FEs under the control of the i^{th} CONTROL DOMAIN server is t. A counter of a number of FEs is called j.

### Procedure

1. As soon as the i^{th} CONTROL DOMAIN server goes up it sends to the t FEs under its control a FullInfo Request message. This message requests the Recovery Status of all the LSPs for which the j^{th} FE is Ingress
2. Each FE receiving the FullInfo Request message replies with the requested information. That message is Call based and thus the FE sends (i, j) FullInfo Response messages where (i, j) is the number of Circuits for which the j^{th} FE of the i^{th} CONTROL DOMAIN server is Ingress
3. The i^{th} CONTROL DOMAIN server collects all the FullInfo Response messages (there is a FullInfo Response for each FullInfo Request) and builds its Circuit list with the Recovery Status info. When the last message is received the i^{th} CONTROL DOMAIN server tries to connect to the NMS
4. NMS sends to the i^{th} CONTROL DOMAIN server tᵢ Realignment Requests, where tᵢ is the number of FEs under the control of the i^{th} CONTROL DOMAIN server.
5. The CONTROL DOMAIN server replies with tᵢ Realignment Response. Each of these messages contains the Recovery Status information about the (i, j) Circuit for which the FE is Ingress FE.
6. At the receiving of each Realignment Response message the NMS updates, if necessary, the recovery status of the LSPs.

### End of the Procedure.

### FIGS. 9 and 10, Network Element Misalignment

FIGS. 9 and 10 show examples illustrating the scenario in which the FE has failed. In this scenario a GMPLS failure for example is taken into consideration. In order to avoid complex and delicate re-alignment procedures between the NMS Database and a FE database, the FEs do not maintain persistent information about the Circuit/LSP.

In FIG. 9, the FE recovers from failure at step 400. The FE asks the CDS for a copy of records of its circuits at step 410. The CDS forwards an indication to the NMS of this request. The NMS sends a copy of its records for that FE to the CDS at step 430. The CDS sends that copy on to the FE at step 440. The FE checks for inconsistencies between the copy and its own record at step 450. At step 460, the FE updates its own record from the copy if inconsistency is found.

FIG. 10 shows a time chart of parts of a similar procedure with FE Upload of Call/LSP Information according to an embodiment. Time flows downwards. Actions of the NMS and its database are at the left side. Actions of the CDS are in a central column, and actions of the FE are at the right side. This figure illustrates an example of the message flow in the case that the FE fails. In this case the FE cannot be sure about the status of its records and thus an update is carried out. The following steps take place in this example, described partly in pseudo code terms. Many variations can be envisaged. Procedure
1. As soon as communication such as a GMPLS process re-starts, then an ImAlive message is sent to the CDS, this message indicates that the FE needs to re-build its Call/LSPs information;
2. The CDS:
   2.1. replies with a ImAliveConfirm message. This message avoids the FE re-sending the ImAlive message unnecessarily;
   2.2. an ImAlive message is sent to the NMS;
3. NMS sends a Circuit Realignment Request message to the CDS. This message contains all the LSP traversing the failed FE and is used by the CDS in order to build the LSP based Circuit Information Request messages;
4. The CDS sends a Circuit Information Request message to the failed FE. In case a call is made of Worker and Protection LSPs, Worker LSP information is sent first;
5. The FE sends back a Circuit Information Confirm message for each Circuit Information Request it receives;
   5.1. in the case FE finds some errors during the storage of the Circuit Information Request, information about the error is stored and it is sent to the CDS at the end of the procedure;
6. The end of the procedure is signaled by a special Circuit Information Request message;
   6.1. in the case the FE encountered some errors during the whole procedure the last Circuit Information Confirm contains all the indications about the errors.
7. a Circuit Realignment Confirm is send by the CDS to the NMS as soon as it receives the last Circuit Information Confirm;

In order to minimize the creation of orphans the NMS sends to the restarting FE also the information related to the LSP that it was not able to delete due to the restart of the FE. After the realignment that LSP are deleted with the usual punctual Delete message.

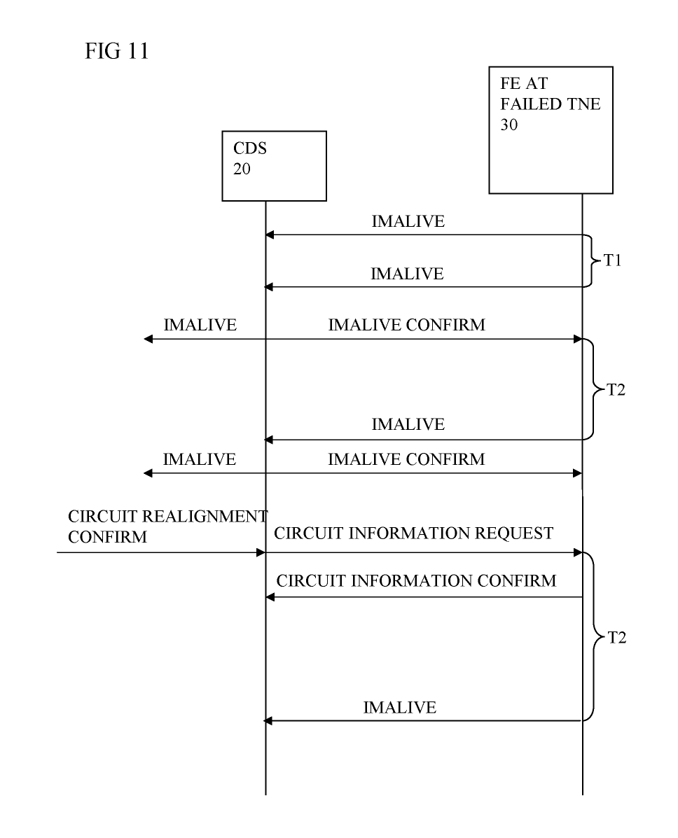

### FIG. 11, Timers

FIG. 11 illustrates the relationship among the various timer and the following actions.

### FE Start-Up Timers:

There are two timers namely T1 and T2:
T1 is the retransmission timer, FE sends indefinitely an ImAlive message until it receives either a ImAliveConfirm or an FullInfo Request;
T2 is an inactivity timer, this timer is restarted each time the FE receives a re-alignment message. At the elapsing of the T2 timer FE starts re-sending ImAlive messages.

Nota Bene: Each time the CDS receives an ImAlive message it restarts the re-alignment procedure. That happens even if the first Information message has been sent.

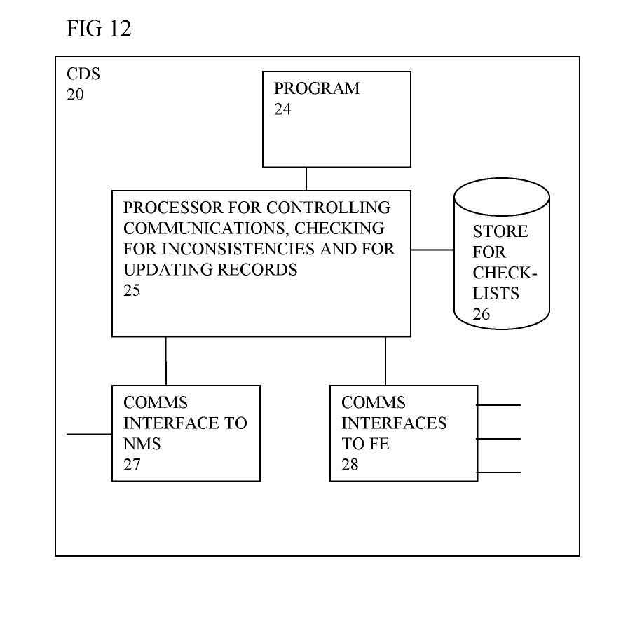

### FIG. 12, Example of a CDS

FIG. 12 shows a schematic view of some features of a CDS. A processor 25 is provided for controlling communications such as message flows described above, for checking for inconsistencies and for updating records. A store 26 is provided for the checklists of circuits. A program 24 is provided for the processor. A communications interface is provided to the NMS 27, and to each of the FEs 28 in the domain. The processor can be implemented in many different ways.

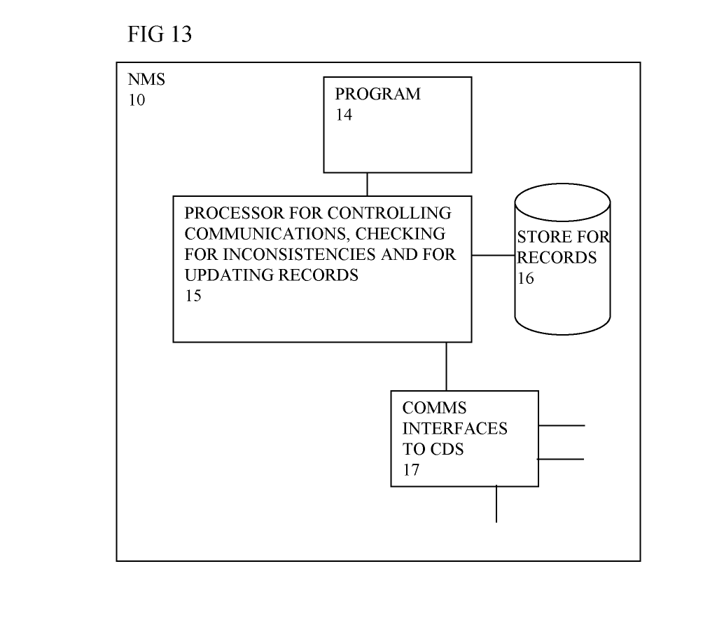

### FIG. 13, Example of an NMS

FIG. 13 shows a schematic view of some features of an NMS. A processor 15 is provided for controlling communications such as message flows described above, for checking for inconsistencies and for updating records. Again the processor can be implemented in many different ways. A store 16 is provided for records of circuits set up. A program 14 is provided for the processor. A communications interface 17 is provided to the NMS.

Other variations can be envisaged within the scope of the claims.

1. A method of operating a control plane for a communications network, the control plane having a centralized network management system, one or more control domain servers coupled to the network management system, and a plurality of forwarding elements, for controlling respective network entities, and grouped into control domains, each domain having a respective one of the control domain servers coupled to the forwarding elements of that domain to manage control plane signaling for the domain, the network management system having a record of the circuits set up in all of the control domains, the forwarding elements having a record of those of the circuits set up to use its respective network entity, the method comprising:
after a failure in a part of the control plane, amongst the control domain server, the forwarding elements, and the network management system, re-establishing communication between those parts of the control plane affected by the failure;
checking automatically for inconsistencies between the records held at the different parts of the control plane, caused by the failure, by comparing checklists of the records of the circuits stored at the different parts of the control plane; and
if an inconsistency is found, updating automatically the records at the part or parts affected by the failure using a copy of a corresponding but more up to date record sent from another of the parts of the control plane.

2. The method of claim 1, further comprising using the control domain server to generate a checklist for any of the forwarding elements of its control domain based on the records held at the respective forwarding element, for use in the step of checking for inconsistencies.

3. The method of claim 1, wherein the checking comprises forwarding a checklist of the records between the control domain server and the network management system, and using either the network management system or the control domain server to compare the checklists for the records held at the different parts without forwarding entire copies of all the records between the network management system and the control domain server.

4. The method of claim 1, wherein at least one of the control domain servers is arranged to maintain a record of current checklists for the forwarding elements of their domain.

5. The method of claim 4, further comprising the steps in case of the failure being at the network management system, of using the checklist in the records at the control domain server, for the comparing step, comparing with corresponding information in the records at the network management system.

6. The method of claim 1, wherein the checking for inconsistencies comprises, for the case of the failure being at the control domain server, of generating current checklists at the control domain server by requesting a copy of circuit information from the records at the forwarding elements in the respective domain.

7. The method of claim 6, wherein the checking step further comprises comparing the current checklist at the control domain server with corresponding information in the records at the network management system.

8. The method of claim 7, wherein the updating step comprises: the control domain server sending a request to selected ones of the forwarding elements to send a copy of the record which needs updating,
the control domain server forwarding the copy to the network management system, and the network management system using these to update its records in relation to the respective forwarding elements.

9. The method of claim 1, wherein the checking for inconsistencies comprises, for the case of the failure being at one of the forwarding elements, of the steps of:
the forwarding element sending to the control domain server an indication that the forwarding element needs to rebuild its records, and the control domain server sending this indication on to the network management system.

10. The method of claim 9, wherein the updating comprises the network management system selecting from its records, information about any circuits using the respective forwarding element, and sending this to the control domain server, the control domain server sending this information to the forwarding element, and the forwarding element updating its records.

11. The method of claim 1, further comprising using the updated records at the parts of the control plane in a restoration procedure for restoring a failed circuit by rerouting onto a new route.

12. A control domain server for a control plane of a communications network, the control plane having a central network management system, one or more control domain servers coupled to the network management system, and a plurality of forwarding elements, for controlling respective network entities, and grouped into control domains, each domain having a respective one of the control domain servers coupled to the forwarding elements of that domain to manage control plane signaling for the domain, the network management system having a record of the circuits set up in all of the control domains, the forwarding elements having a record of those of the circuits set up to use its respective network entity, the control domain server being arranged to:
after the failure, re-establish communication between parts of the control plane affected by the failure, then check for inconsistencies between the records held at the different parts of the control plane, caused by the failure,
the control domain server also being arranged for updating, if an inconsistency is found, the records at the part or parts affected by the failure, by requesting a copy of a corresponding but more up to date record from the respective forwarding element or from the network management system, and forwarding the copy on to the other of these.

13. The control domain server of claim 12, further comprising having a part arranged to generate a checklist for any of the forwarding elements of its control domain based on the records held at the respective forwarding element, for use in the step of checking for inconsistencies.

14. The control domain server of claim 12, having a part arranged to maintain a record of current checklists for the forwarding elements of their domain.

15. A network management system for a control plane of a communications network, the control plane also having one or more control domain servers coupled to the network management system, and a plurality of forwarding elements, for controlling respective network entities, and grouped into control domains, each domain having a respective one of the control domain servers coupled to the forwarding elements of that domain to manage control plane signaling for the domain, the network management system having a record of the circuits set up in all of the control domains, the forwarding elements having a record of those of the circuits set up to use its respective network entity, the network management system being arranged to:
after the failure, re-establish communication between those parts of the control plane affected by the failure, then checking for inconsistencies between the records held at the different parts of the control plane, caused by the failure; and
if an inconsistency is found, update the records affected by the failure, by requesting a copy of a corresponding but more up to date record from the respective forwarding element.

16. A computer program on a non-transitory computer readable medium, for operating a control plane of a communications system, the control plane having a central network management system, one or more control domain servers coupled to the network management system, and a plurality of forwarding elements, for controlling respective network entities, and grouped into control domains, each domain having a respective one of the control domain servers coupled to the forwarding elements of that domain to manage control plane signaling for the domain, the network management system having a record of the circuits set up in all of the control domains, the forwarding elements having a record of those of the circuits set up to use its respective network entity, the computer program having instructions which when executed by a processor or processors at one or more parts of the control plane amongst the control domain server, the network management system and the forwarding element cause the processor or processors to:
after the failure, re-establish communication between those parts of the control plane affected by the failure, then check for inconsistencies between the records held at the different parts of the control plane, caused by the failure; and
if an inconsistency is found, to update the records at the part or parts affected by the failure, by requesting a copy of a corresponding but more up to date record from the respective forwarding element or from the network management system, and forwarding the copy on to the other of these.
